(19) United States
(12) Patent Application Publication
(10) Pub. No.: US 2026/0100029 A1
(43) Pub. Date: Apr. 9, 2026

(54) METHOD FOR TRAINING A NEURAL NETWORK FOR DETECTING AN OBJECT AND METHOD FOR DETECTING AN OBJECT VIA A NEURAL NETWORK

(71) Applicant: SEW-EURODRIVE GMBH & CO. KG, Bruchsal (DE)

(72) Inventors: Thomas SCHÄFER, Karlsdorf-Neuthard (DE); Leon Rafael SCHÖNFELD, Speyer (DE)

(73) Assignee: SEW-EURODRIVE GMBH & CO. KG, Bruchsal (DE)

(21) Appl. No.: 19/112,280

(22) PCT Filed: Jul. 27, 2023
(86) PCT No.: PCT/EP2023/070868

§ 371 Date: Mar. 17, 2025

(30) Foreign Application Priority Data
Sep. 15, 2022 (DE) 10 2022 003 398.4

(51) Int. Cl. G06V 10/82; G06T 7/70

(52) U.S. Cl. CPC G06V 10/82; G06T 7/70; G06T 2207/10048

(57) ABSTRACT

In a method for training a neural network for detecting an object, geometric dimensions of a test object from an object class are captured, and during a time period, recordings of the test object are generated by a plurality of cameras. From the captured geometric dimensions and the generated recordings, occupancy maps are generated. By a radar device, a radar signal is transmitted, and a radar signal reflected by the test object is received. The transmitted radar signal and the received radar signal are mixed into a complex baseband to form a mixed signal. A complex four-dimensional mixed spectrum of the mixed signal is calculated. From the complex four-dimensional mixed spectrum, a first complex two-dimensional partial spectrum and a second complex two-dimensional partial spectrum are calculated. The occupancy maps and the partial spectra are fusioned to form training data. The training data are fed to the neural network.

### FIELD OF THE INVENTION

The present invention relates to a method for training a neural network for detecting an object. Training data are generated and fed into the neural network. The present invention also relates to a method for detecting an object via a neural network.

### BACKGROUND INFORMATION

In image processing for camera systems, the use of neural networks for recognizing objects in images is already common practice and delivers excellent results. In certain conventional systems, neural networks are used to localize objects in images and include convolutional neural networks (CNN) in an autoencoder structure. The prerequisite for successful localization and classification of an object via a neural network is that the neural network has been trained accordingly.

A convolutional network includes various convolutional layers, which together represent the intelligence of the neural network. This includes an input layer and an output layer. The layers are linked to each other via mathematical convolution operations. In image processing, an image is fed to the input layer and a map with the object positions of the objects on the image is output at the output layer.

Algorithms such as CFAR (Constant False Alarm Rate) are usually used to recognize objects using radar data, but these provide inadequate results under many conditions. Algorithms such as CFAR follow strict patterns according to which they generate their output and are dependent on preset parameters. If these parameters are chosen unfavorably, the result can be significantly worse than originally assumed. The current state of image processing with neural networks shows that they can localize and classify objects independently of the state of the existing images.

A method for training a neural network is described in European Patent Document No. 3 690 727, in which a camera and a radar are used together.

An evaluation device, a training system, and a training method for obtaining a segmentation of a radar recording of an environment are described in German Patent Document No. 10 2018 203 684.

A system and a method, which relate to a sensor fusion based on machine learning for applications of autonomous machines, are described in German Patent Document No. 11 2021 000 135.

A device and a method for generating verified training data for a self-learning system are described in German Patent Document No. 10 2019 219 894.

A neural network for detecting obstacles for use in autonomous vehicles is described in European Patent Document No. 3 832 341, in which radar sensors are used.

### SUMMARY

Example embodiments of the present invention provide a method for training a neural network for detecting an object and a method for detecting an object via a neural network.

A method for training a neural network for detecting an object is described herein. The geometric dimensions of a test object from an object class are captured. During a time period, recordings of the test object are generated by a plurality of cameras. From the captured geometric dimensions and the generated recordings, occupancy maps are generated. By a radar device, a radar signal is transmitted and a radar signal reflected by the test object is received. The transmitted radar signal and the received radar signal are mixed into a complex baseband to form a mixed signal and a complex four-dimensional mixed spectrum of the mixed signal is calculated. From the complex four-dimensional mixed spectrum a first complex two-dimensional partial spectrum and a second complex two-dimensional partial spectrum are calculated. The occupancy maps and the partial spectra are fusioned to form training data, and the training data are fed to the neural network.

The training data contains a sufficient number of mixed spectra, which contain radar images linked to information about the location of a test object and the object class to which the test object is assigned. This information is referred to as ground truth. When the occupancy maps are generated, cells containing the test object are assigned a high value, and cells that are empty are assigned a low value. The probability that a test object of a certain object class occupies a location in the radar device's field of view can be taken from the respective occupancy maps. The most probable test object can be extracted via a hard decision threshold.

According to example embodiments, the mixed spectrum contains information about a distance, an azimuth angle, an elevation angle, and a radial velocity of the test object. The radial velocity is determined via a frequency shift between the transmitted radar signal and the reflected radar signal. The frequency shift in question results from the Doppler effect of moving objects.

According to example embodiments, the first partial spectrum contains information about a distance and an azimuth angle of the test object, and the second partial spectrum contains information about a distance and a radial velocity of the test object.

According to example embodiments, the first partial spectrum contains a first radar image with information about an amount of the distance and the azimuth angle of the test object. The first partial spectrum also contains a second radar image with information about a phase of the distance and the azimuth angle of the test object. The second partial spectrum contains a third radar image with information about an amount of the distance and the radial velocity of the test object. The second partial spectrum also contains a fourth radar image with information about a phase of the distance and the radial velocity of the test object. The radar images are, for example, available in polar coordinates.

According to example embodiments, the test object is moved during the time period. In this manner, several different recordings of the test object are generated at different locations and with different orientations, and corresponding mixed spectra are calculated. The quality of the training data is improved by a higher number of different recordings with corresponding mixed spectra.

According to example embodiments, the occupancy maps are first created in Cartesian coordinates, and the Cartesian coordinates are then transformed into polar coordinates. The Cartesian coordinates are transformed into polar coordinates before the occupancy maps and the partial spectra are fusioned into the training data. This provides for compatibility of the occupancy maps with the partial spectra, whose radar images are also available in polar coordinates.

According to example embodiments, markings are applied to the test object before the recordings are generated such that the markings are visible in the generated recordings. If such markings are attached to a test object, a six-dimensional pose of the test object can be calculated, which includes a position of the test object and an orientation of the test object.

According to example embodiments, the cameras are arranged as infrared cameras and/or the markings are arranged as infrared markers. The cameras and the markings are part of a position capturing system. For example, such markings on the test object allow an exact calculation of a six-dimensional pose of the test object, which includes a position of the test object and an orientation of the test object.

According to example embodiments, a respective pose of the test object is calculated from the recordings, which pose, in each case, includes a position of the test object and an orientation of the test object. The calculated poses are discretized and integrated into the occupancy maps.

According to example embodiments, the method steps are repeated for at least one further test object from a further object class. The occupancy maps and/or the training data are assigned to the respective object class. Such object classes are, for example, people, forklift trucks, or autonomous transport vehicles.

According to example embodiments, the neural network is arranged as a convolutional network, which has an input layer, an output layer, and a plurality of convolutional layers. For example, the neural network is arranged as a CNN (Convolutional Neural Networks) in an autoencoder structure. The layers are arranged in series and linked to each other via mathematical convolution operations. A convolution operation is carried out from one layer to the next. The convolution operators, with which the convolution operations are carried out, are determined by processing the training data fed to the neural network.

A method for detecting an object via a neural network is also described herein, in which the neural network is previously fed training data. The training data are fed to the neural network using the method for training a neural network described herein. A radar signal is transmitted and a radar signal reflected by the object is received by a radar sensor. The transmitted radar signal and the received radar signal are mixed to form a mixed signal, and a mixed spectrum of the mixed signal is calculated. The neural network is fed input data containing the mixed spectrum. The input data are processed in the neural network. The object and a position of the object are detected by the neural network. An object class of the detected object and the detected position of the object are output by the neural network as output data.

The more independent dimensions are available to the neural network as input data, the more effective is the classification of the object via unique features. A unique signature in the mixed spectrum provides for a robust classification.

According to example embodiments, the neural network is arranged as a convolutional network, which has an input layer, an output layer, and a plurality of convolutional layers. A convolution operation is respectively carried out from one layer to the next. The layers are arranged in series and linked to each other via mathematical convolution operations. A convolution operation is respectively carried out from one layer to the next.

According to example embodiments, the calculated mixed spectrum includes at least a distance and an azimuth angle of a radar measurement. The neural network is fed first input data containing the distance of the radar measurement. The neural network is fed second input data containing the azimuth angle of the radar measurement. The first input data and the second input data represent a first complex image from complex data. The first complex image thus includes two simple images containing amount and phase.

According to example embodiments, the calculated mixed spectrum includes at least a distance and a radial velocity of a radar measurement. The neural network is fed third input data containing the distance of the radar measurement. The neural network is fed fourth input data containing the radial velocity of the radar measurement. The third input data and the fourth input data represent a second complex image from complex data. The second complex image thus includes two simple images containing amount and phase.

Further features and aspects of example embodiments of the present invention are explained in more detail below with reference to the appended schematic Figures.

### BRIEF DESCRIPTION OF THE DRAWINGS

FIG. 1 schematically illustrates an arrangement for obtaining training data.

FIG. 2 schematically illustrates a neural network.

FIG. 3 schematically illustrates input data of a neural network.

FIG. 4 schematically illustrates output data of a neural network.

### DETAILED DESCRIPTION

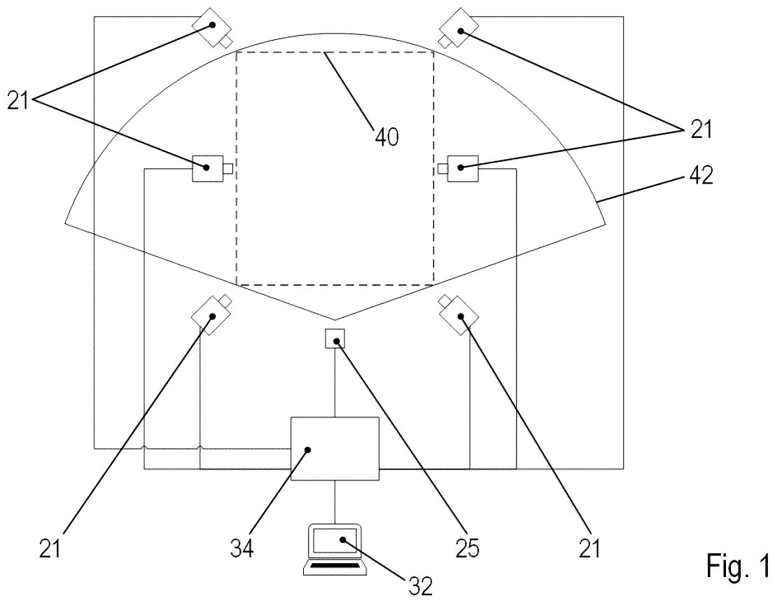

FIG. 1 schematically illustrates an arrangement for obtaining training data for a neural network 7. The arrangement has a measuring region 40 and a radar region 42. The measuring region 40 and the radar region 42 largely overlap. A test object is located within the measuring region 40 and within the radar region 42.

The arrangement includes a radar device 25. The radar device 25 is arranged such that a test object located within the radar region 42 can be captured by the radar device 25. The radar region 42 is in the form of a circular sector. The radar device 25 is arranged at the top of the circular sector.

The radar device 25 transmits a radar signal and receives a radar signal, which is reflected by the test object. The radar device 25 has a multiplier. The transmitted radar signal and the received radar signal are mixed by the multiplier into a complex baseband to form a mixed signal. A complex four-dimensional mixed spectrum of the mixed signal is also calculated in the radar device 25. The mixed spectrum is calculated via a discrete Fourier transformation from sampled raw data of the mixed signal.

The radar device 25 has a 2-D MIMO (Multiple Input Multiple Output) antenna array. The transmitted radar signal has a FMCW (Frequency-Modulated Continuous Wave) modulation. The calculated mixed spectrum is thus four-dimensional and contains information about a distance, an azimuth angle, an elevation angle, and a radial velocity of the test object from which the radar signal is reflected.

From the complex four-dimensional mixed spectrum, a first complex two-dimensional partial spectrum and a second complex two-dimensional partial spectrum are calculated. The first partial spectrum contains information about a distance and an azimuth angle of the test object, and the second partial spectrum contains information about a distance and a radial velocity of the test object.

The first partial spectrum contains a first radar image with information about an amount of the distance and the azimuth angle of the test object. The first partial spectrum also contains a second radar image with information about a phase of the distance and the azimuth angle of the test object. The second partial spectrum contains a third radar image with information about an amount of the distance and the radial velocity of the test object. The second partial spectrum also contains a fourth radar image with information about a phase of the distance and the radial velocity of the test object. The radar images are available in polar coordinates.

The arrangement includes a plurality of cameras 21 for generating recordings. Six cameras 21 are included, for example. The cameras 21 are arranged such that a test object located within the measuring region 40 can be captured by all cameras 21. The measuring region 40 is in the form of a rectangle. The cameras 21 are arranged at the corners and side lines of the rectangle. The cameras 21 are arranged as infrared cameras and are part of a position capturing system.

The arrangement further includes a digital computer 32 and a processing unit 34. The cameras 21 are connected to the processing unit 34 and transmit generated recordings to the processing unit 34. The radar device 25 is also connected to the processing unit 34 and transmits data to the processing unit 34. The processing unit 34 is connected to the digital computer 32 and transmits data to the digital computer 32.

To obtain the training data for the neural network 7, a test object is first selected from an object class. Object classes are, for example, people, forklift trucks, or autonomous transport vehicles. The selected test object is thus, for example, a person, a forklift truck, or an autonomous transport vehicle.

First, the geometric dimensions of the test object are captured. For example, the length, width, and height of the test object are measured. Markings are also applied to the test object. The markings are arranged as infrared markers. As mentioned above, the cameras 21 are arranged as infrared cameras. The markings are applied to the test object such that the markings are visible in recordings subsequently generated by the cameras 21.

The training data for the neural network 7 are obtained during a previously defined period of time with the help of the selected test object. During this time period, the test object is moved in a region that lies within the measuring region 40 and within the radar region 42. Where applicable, the test object moves independently in this region during the time period.

During this period, the cameras 21 generate recordings of the test object. A pose of the test object is respectively calculated from the recordings. The pose is six-dimensional and respectively includes one position of the test object and one orientation of the test object.

Occupancy maps are created from the previously captured geometric dimensions of the test object and the generated recordings. The calculated poses are integrated into the occupancy maps. The occupancy maps are assigned to the object class of the selected test object. The occupancy maps are first created in Cartesian coordinates, and the Cartesian coordinates are then transformed into polar coordinates.

During said period of time, simultaneously a radar signal is transmitted by the radar device 25 and a radar signal reflected by the test object is received. The transmitted radar signal and the received radar signal are mixed to form a mixed signal. A complex four-dimensional mixed spectrum of the mixed signal is also calculated. From the complex four-dimensional mixed spectrum, a first complex two-dimensional partial spectrum and a second complex two-dimensional partial spectrum are calculated. The partial spectra contain radar images which are available in polar coordinates.

The occupancy maps and the partial spectra are then fusioned into training data. The training data are assigned to the respective object class of the selected test object. The training data obtained in this manner are fed to the neural network 7.

The process steps described for obtaining the training data for the neural network 7 are repeated for further test objects from further object classes. Test objects are selected from other object classes. Furthermore, the process steps described for obtaining the training data for the neural network 7 are carried out once without a real test object, but with a free space. The occupancy maps and the training data are assigned to the respective object class or free space.

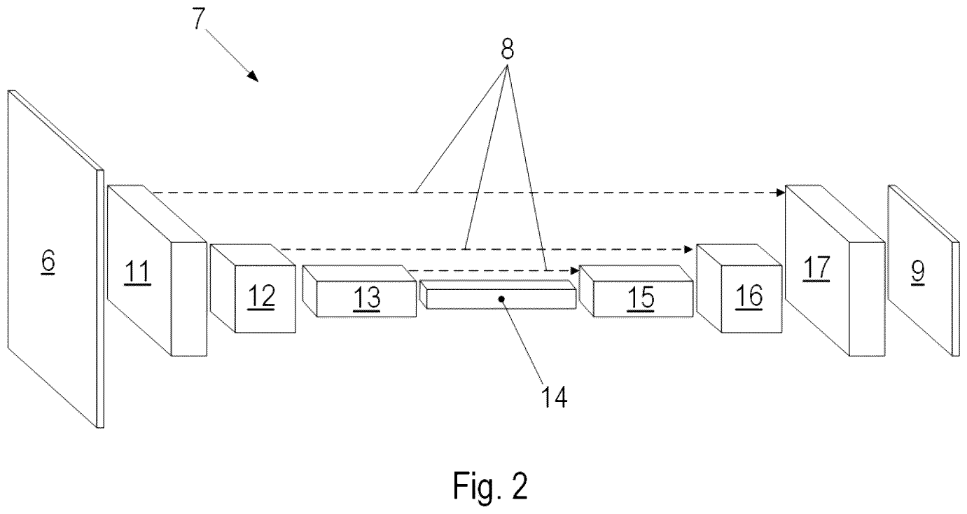

FIG. 2 schematically illustrates a neural network 7. The neural network 7 is arranged as a convolutional network. For example, the neural network 7 has an input layer 6, a first convolutional layer 11, a second convolutional layer 12, a third convolutional layer 13, a fourth convolutional layer 14, a fifth convolutional layer 15, a sixth convolutional layer 16, a seventh convolutional layer 17, and an output layer 9.

Input data 1, 2, 3, 4 are fed to the input layer 6 of the neural network 7. The input layer 6, the convolutional layers 11, 12, 13, 14, 15, 16, 17, and the output layer 9 are arranged in series one after the other. A convolution operation is respectively carried out from one layer to the next. Output data 51, 52, 53, 54 are output from the output layer 9 of the neural network 7.

Furthermore, an intermediate connection 8 is provided between the first convolutional layer 11 and the seventh convolutional layer 17. An intermediate connection 8 is also provided between the second convolutional layer 12 and the sixth convolutional layer 16. An intermediate connection 8 is also provided between the third convolutional layer 13 and the fifth convolutional layer 15. The intermediate connections 8 represent direct transfers between two layers, in which no convolution operation is carried out via the intermediate connection 8. The intermediate connections 8 are used to accelerate the training phase. This is a heuristic.

Each of the layers represents a three-dimensional matrix of individual pixels. For example, the input layer 6 has a size of 4×128×128 pixels. The first convolutional layer 11 has a size of 16×64×64 pixels. The second convolutional layer 12 has a size of 32×32×32 pixels. The third convolutional layer 13 has a size of 64×16×16 pixels. The fourth convolutional layer 14 has a size of 128×8×8 pixels. The fifth convolutional layer 15 has a size of 64×16×16 pixels. The sixth convolutional layer 16 has a size of 32×32×32 pixels. The seventh convolutional layer 17 has a size of 16×64×64 pixels. The output layer 9 has a size of 4×64×64 pixels.

A radar measurement is carried out to detect an object via the neural network 7 to which the training data are previously fed. A radar signal is transmitted and a radar signal reflected by the object is received by a radar sensor. The transmitted radar signal and the received radar signal are mixed to form a mixed signal. A mixed spectrum of the mixed signal is calculated.

The calculated mixed spectrum includes a distance of the radar measurement and an azimuth angle of the radar measurement. The calculated mixed spectrum also includes a distance of the radar measurement and a radial velocity of the radar measurement.

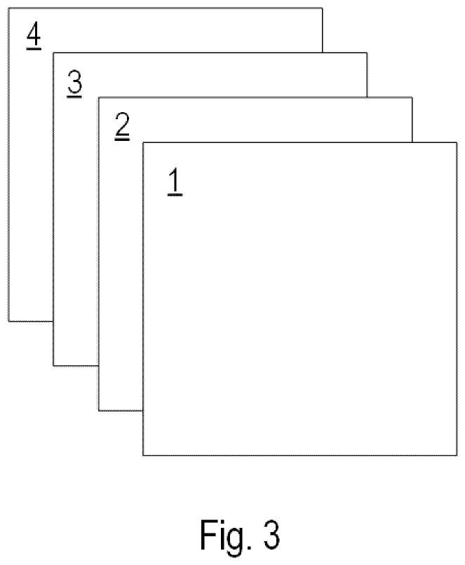

Input data 1, 2, 3, 4 containing the mixed spectrum are fed to the input layer 6 of the neural network 7. FIG. 3 schematically illustrates input data 1, 2, 3, 4 of the neural network 7.

The first input data 1, which contain the distance of the radar measurement, are fed to the input layer 6 of the neural network 7. The first input data 1 represent a two-dimensional matrix of individual pixels. For example, the first input data 1 have a size of 128×128 pixels.

The second input data 2, which contain the azimuth angle of the radar measurement, are fed to the input layer 6 of the neural network 7. The second input data 2 represent a two-dimensional matrix of individual pixels. For example, the second input data 2 have a size of 128×128 pixels.

The third input data 3, which contain the distance of the radar measurement, are fed to the input layer 6 of the neural network 7. The third input data 3 represent a two-dimensional matrix of individual pixels. For example, the third input data 3 have a size of 128×128 pixels.

The fourth input data 4, which contain the radial velocity of the radar measurement, are fed to the input layer 6 of the neural network 7. The fourth input data 4 represent a two-dimensional matrix of individual pixels. For example, the fourth input data 4 have a size of 128×128 pixels.

The input data 1, 2, 3, 4 are processed in the neural network 7. A convolution operation is respectively carried out from one layer to the next. The object and a position of the object are detected by the neural network 7 as a result of the successive convolution operations. An object class of the object is also detected by the neural network 7 as a result of the successive convolution operations.

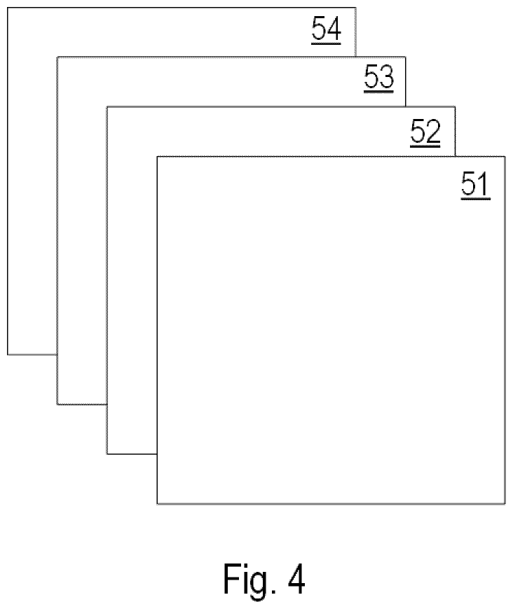

Output data 51, 52, 53, 54 are output from the output layer 9 of the neural network 7. FIG. 4 schematically illustrates output data 51, 52, 53, 54 of the neural network 7.

The first output data 51 are assigned to an object from a first object class, for example, a person. The first output data 51 contain the detected position of the object. The first output data 51 represent a two-dimensional matrix of individual pixels. For example, the first output data 51 has a size of 64×64 pixels.

The second output data 52 are assigned to an object from a second object class, for example, a forklift truck. The second output data 52 contain the detected position of the object. The second output data 52 represent a two-dimensional matrix of individual pixels. For example, the second output data 52 have a size of 64×64 pixels.

The third output data 53 are assigned to an object from a third object class, for example, an autonomous transport vehicle. The third output data 53 contain the detected position of the object. The third output data 53 represent a two-dimensional matrix of individual pixels. For example, the third output data 53 have a size of 64×64 pixels.

The fourth output data 54 are assigned to an object from a fourth object class, for example, free space. The fourth output data 54 contain the detected position of the object. The fourth output data 54 represent a two-dimensional matrix of individual pixels. For example, the fourth output data 54 have a size of 64×64 pixels.

### LIST OF REFERENCE NUMERALS

1 First input data
2 Second input data
3 Third input data
4 Fourth input data
6 Input layer
7 Neural network
8 Intermediate connection
9 Output layer
11 First convolutional layer
12 Second convolutional layer
13 Third convolutional layer
14 Fourth convolutional layer
15 Fifth convolutional layer
16 Sixth convolutional layer
17 Seventh convolutional layer
21 Camera
25 Radar device
32 Digital computer
34 Processing unit
40 Measurement region
42 Radar region
51 First output data
52 Second output data
53 Third output data
54 Fourth output data

1 to 15. (canceled)

16. A method for training a neural network for detecting an object, comprising:
capturing geometric dimensions of a test object from an object class;
during a time period, generating recordings of the test object by a plurality of cameras;
generating, from the captured geometric dimensions and the generated recordings, occupancy maps;
transmitting, by a radar device, a radar signal, and receiving, by the radar device, a radar signal reflected by the test object;
mixing the transmitted radar signal and the received radar signal into a complex baseband to form a mixed signal;
calculating a complex four-dimensional mixed spectrum of the mixed signal;
calculating, from the complex four-dimensional mixed spectrum, a first complex two-dimensional partial spectrum and a second complex two-dimensional partial spectrum;
fusioning the occupancy maps and the partial spectra to form training data; and
feeding the training data to the neural network.

17. The method according to claim 16, wherein the mixed spectrum includes information relating to a distance, an azimuth angle, an elevation angle, and a radial velocity of the test object.

18. The method according to claim 16, wherein the first partial spectrum includes information relating to a distance and an azimuth angle of the test object, and the second partial spectrum includes information relating to a distance and a radial velocity of the test object.

19. The method according to claim 18, wherein the first partial spectrum includes a first radar image with information relating to an amount of the distance and the azimuth angle of the test object, the first partial spectrum includes a second radar image with information relating to a phase of the distance and the azimuth angle of the test object, the second partial spectrum includes a third radar image with information relating to an amount of the distance and the radial velocity of the test object, and the second partial spectrum includes a fourth radar image with information relating to a phase of the distance and the radial velocity of the test object.

20. The method according to claim 16, further comprising moving the test object during the time period.

21. The method according to claim 16, wherein the occupancy maps are first created in Cartesian coordinates, and the Cartesian coordinates are transformed into polar coordinates.

22. The method according to claim 16, wherein markings are applied to the test object before the recordings are generated such that the markings are visible in the generated recordings.

23. The method according to claim 16, wherein the cameras include infrared cameras.

24. The method according to claim 22, wherein the cameras include infrared cameras, and the markings include infrared markers.

25. The method according to claim 16, further comprising calculating a respective pose of the test object from the recordings, each pose including a position of the test object and an orientation of the test object, and integrating the calculated poses into the occupancy maps.

26. The method according to claim 16, further comprising repeating the method for at least one further test object from a further object class, and assigning the occupancy maps and/or the training data to a respective object class.

27. The method according to claim 16, wherein the neural network includes a convolutional network having an input layer, an output layer, and a plurality of convolutional layers.

28. A method for detecting an object via a neural network to which training data were previously fed according to the method recited in claim 16, comprising:
transmitting, by a radar sensor, a radar signal, and receiving, by the radar sensor, a radar signal reflected by the object;
mixing the transmitted radar signal and the received radar signal to form a mixed signal;
calculating a mixed spectrum of the mixed signal;
feeding input data including the mixed spectrum to the neural network;
processing the input data in the neural network;
detecting the object and a position of the object by the neural network; and
outputting an object class of the detected object and the detected position of the object by the neural network as output data.

29. The method according to claim 28, wherein the neural network includes a convolutional network having an input layer, an output layer, and a plurality of convolutional layers, a convolution operation being respectively performed from one layer to the next.

30. The method according to claim 28, wherein the calculated mixed spectrum includes a distance and an azimuth angle of a radar measurement, first input data including the distance of the radar measurement are fed to the neural network, and second input data including the azimuth angle of the radar measurement are fed to the neural network.

31. The method according to claim 28, wherein the calculated mixed spectrum includes a distance and a radial velocity of a radar measurement, third input data including the distance of the radar measurement are fed to the neural network, and fourth input data including the radial velocity of the radar measurement are fed to the neural network.

32. The method according to claim 31, wherein the calculated mixed spectrum includes a distance and a radial velocity of the radar measurement, third input data including the distance of the radar measurement are fed to the neural network, and fourth input data including the radial velocity of the radar measurement are fed to the neural network.
